(19) United States
(12) Patent Application Publication
(10) Pub. No.: US 2025/0178853 A1
(43) Pub. Date: Jun. 5, 2025

(54) DEVICE FOR AUTOMATICALLY REMOVING FINISH TAPE ATTACHED TO FILM MEMBER WINDING ROLL

(71) Applicants: Philenergy Co., Ltd, Osan-si (KR); DOWONWIZTEC CO., LTD., Hwaseong-si (KR)

(72) Inventors: Dae Sik KIM, Hwaseong-si (KR); Kun Hee LEE, Pyeongtaek-si (KR); Taek Su LEE, Hwaseong-si (KR); Young In CHOI, Hwaseong-si (KR)

(73) Assignees: Philenergy Co., Ltd, Osan-si (KR); DOWONWIZTEC CO., LTD., Hwaseong-si (KR)

(21) Appl. No.: 18/950,306

(22) Filed: Nov. 18, 2024

(30) Foreign Application Priority Data
Nov. 30, 2023 (KR) 10-2023-0170743

(51) Int. Cl. B65H 19/10

(52) U.S. Cl. CPC B65H 19/105; B65H 2301/46043; B65H 2701/1311

(57) ABSTRACT

The present invention relates to a device for automatically removing a finish tape attached to a film member winding roll, the device including a finish tape removing part that removes the finish tape attached to the film member winding roll, wherein the finish tape removing part includes a mounting frame portion, a tape mounting portion rotatably installed on one side of the mounting frame portion, a separation removal portion that is spaced apart from the tape mounting portion, allows an adhesive surface of a separation removal tape to face an outside, and separates the finish tape from the film member while the adhesive surface is attached to the finish tape of an adjacent film member winding roll, and a tape collecting portion that is spaced apart from the separation removal portion and collects the separation removal tape to which the finish tape introduced through the separation removal portion is attached.

### CROSS-REFERENCE TO RELATED APPLICATION

This application claims priority to and the benefit of Korean Patent Application No. 10-2023-0170743 filed on Nov. 30, 2023, the disclosure of which is incorporated herein by reference in its entirety.

### BACKGROUND

### 1. Field of the Invention

The present invention relates to a device for automatically removing a finish tape attached to a film member winding roll.

### 2. Discussion of Related Art

FIG. 12 is a configuration diagram of a general film member winding roll. As illustrated in FIG. 12, a film member 11 such as a secondary battery separator is wound on a bobbin and manufactured and supplied in the form of a winding roll 10. In this case, a finish tape 13 (hereinafter referred to as a “finish tape”) is attached to a film member end 12 of the film member winding roll 10 to prevent unwinding. The finish tape 13 is formed in any of various forms, and as illustrated in FIG. 12, a barcode is printed thereon to record product information. Thus, in order to use the film member winding roll 10 provided in this way for a specific process, the finish tape 13 should be removed. For example, in order to use a separator, the finish tape 13 should be removed before a separator winding roll is mounted on a corresponding spool. Since the separator is made of a vinyl-like material, the finish tape 13 is in close contact with the separator. Thus, a sharp tool is used to remove the finish tape 13, which is manually performed, resulting in a cut accident.

To solve this problem, Korean Patent Registration No. 10-2517528 (registered date: Mar. 30, 2023) has been disclosed, but this technology has a complex structure or removal process including a suction process and a removal process, and accordingly, efficiency problems may occur.

### SUMMARY OF THE INVENTION

The present invention is directed to providing a device for automatically removing a finish tape attached to a film member winding roll. The present invention is also directed to providing a device for automatically removing a finish tape attached to a film member winding roll in order for fully unmanned automatic material exchange for a secondary battery winder and a capacitor winder.

A device for automatically removing a finish tape attached to a film member winding roll includes a finish tape removing part that removes the finish tape attached to the film member winding roll, wherein the finish tape removing part includes a mounting frame portion, a tape mounting portion rotatably installed on one side of the mounting frame portion, a separation removal portion that is spaced apart from the tape mounting portion, allows an adhesive surface of a separation removal tape to face an outside, and separates the finish tape from the film member while the adhesive surface is attached to the finish tape of an adjacent film member winding roll, and a tape collecting portion that is spaced apart from the separation removal portion and collects the separation removal tape to which the finish tape introduced through the separation removal portion is attached.

The tape mounting portion may include a third driving portion that rotationally drives the tape mounting portion at a rear surface of the mounting frame portion.

The separation removal portion may include a transfer portion having a cushion and at least one support that is provided inside the transfer portion, supports the transfer portion, and provides a rotational force.

The support may include a first support portion and a second support portion formed at both inner ends of the transfer portion and a third support portion located below the first support portion and the second support portion.

The first support portion and the second support portion may be connected to a rotary shaft of a second driving portion through a first power transmission unit and a second power transmission unit and rotate in conjunction with rotational driving of the second driving portion.

The tape collecting portion may be rotatably installed in the mounting frame portion and connected to the rotary shaft of the second driving portion on a rear surface of the mounting frame portion.

At least one of the transfer portion and the at least one support may have a cushion.

The finish tape removing part may further include a coupling frame portion that is mounted on a rail of a base part formed on a lower surface of the mounting frame portion and moves to a predetermined distance.

The coupling frame portion may include a rail seating portion formed on a lower surface thereof and seated on the rail of the base part and may be connected to a direction changing portion of the base part on one side thereof.

The device may further include a base part that moves the finish tape removing part to a predetermined distance.

The base part may include a first driving portion formed on one side thereof, a rotation screw that rotates in place by driving the first driving portion, a direction changing portion which is mounted on the rotation screw, of which the other side is fixed to the coupling frame portion of the finish tape removing part, and which converts a rotational movement of the rotation screw into a linear movement, and moves the coupling frame portion according to the linear movement, and a pair of rails on which a rail seating portion of the finish tape removing part is seated.

The separation removal portion may guide driving while rotating so that a tape of a separation removal tape roll mounted on the tape mounting portion is withdrawn and is collected and wound on the tape collecting portion.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a device for automatically removing a finish tape attached to a film member winding roll according to an embodiment of the present invention;

FIG. 2 is a perspective view of FIG. 1 at another angle;

FIG. 3 is a rear perspective view of FIG. 1;

FIG. 4 is a plan view of FIG. 1;

FIG. 5 is a front view of FIG. 1;

FIG. 6 is a view illustrating a state in which a cover is removed in FIG. 5;

FIG. 7 is a perspective view of a state in which a transfer part is separated in FIG. 2;

FIG. 8 is a diagram in which a separation removal tape is mounted according to the embodiment of the present invention;

FIGS. 9 to 11 are enlarged configuration diagrams of a separation removal portion for describing an operation state of the present invention; and

FIG. 12 is a configuration diagram of a general film member winding roll.

### DETAILED DESCRIPTION OF EXEMPLARY EMBODIMENTS

Embodiments of the present invention will be described in more detail below with reference to the accompanying drawings. Prior to this, terms or words used in the specification and the appended claims should not be interpreted as being limited to usual or dictionary meanings and should be interpreted as meanings and concepts corresponding to the technical spirit of the present invention according to the principle that the inventor may properly define the concepts of the terms in order to describe his/her own disclosure in the best way. Thus, configurations illustrated in the embodiments and the drawings described herein are merely some of most preferable embodiments of the present invention and do not represent all of the technical spirits of the present invention. Thus, it should be understood that various equivalents and modifications that may replace the configurations at a time of the present application. Further, in order to help understand the invention, components are not illustrated in the accompanying drawings at an actual scale, and dimensions of some components may be exaggeratedly illustrated. Further, the same reference numerals may be assigned to the same components in different embodiments.

Further, it should be noted that, when the reference numerals are added to the components of the drawings, the same components have the same reference numerals as much as possible even when the components are illustrated in different drawings. Further, in describing the present invention, when it is determined that a detailed description of the related known function or configuration may unnecessarily obscure the gist of the present invention, a detailed description thereof will be omitted.

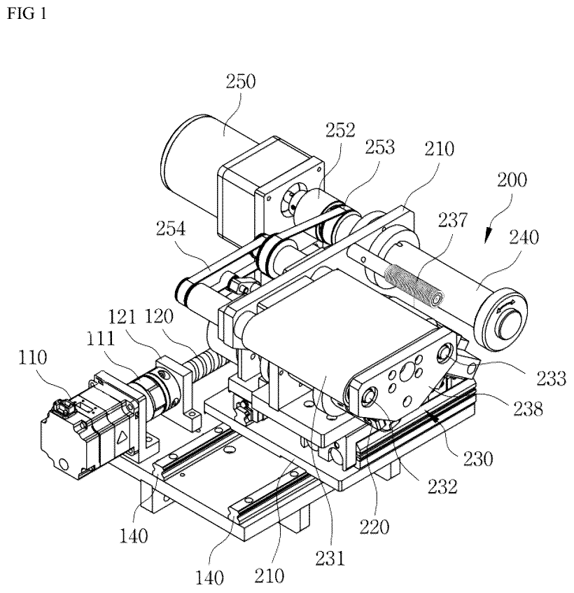

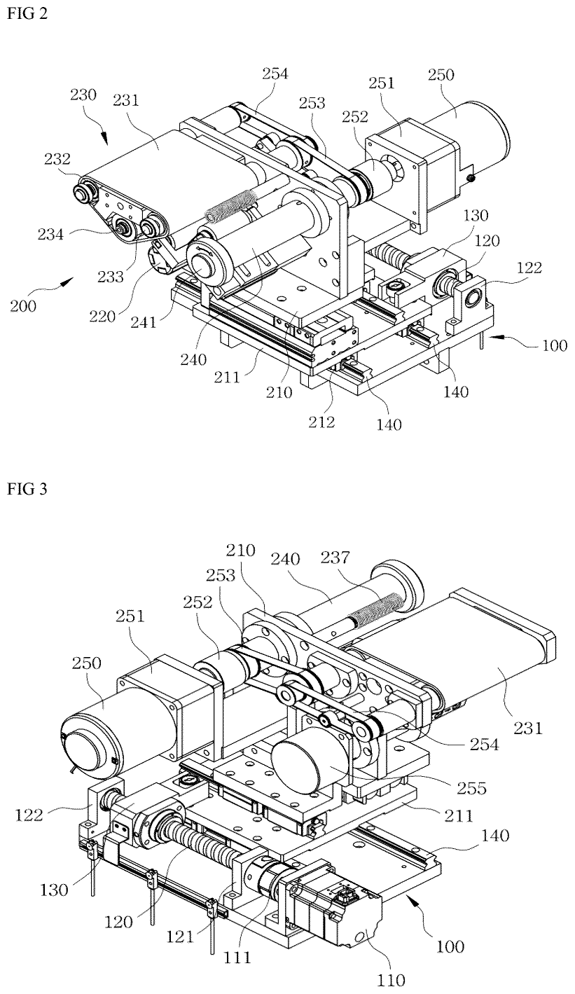

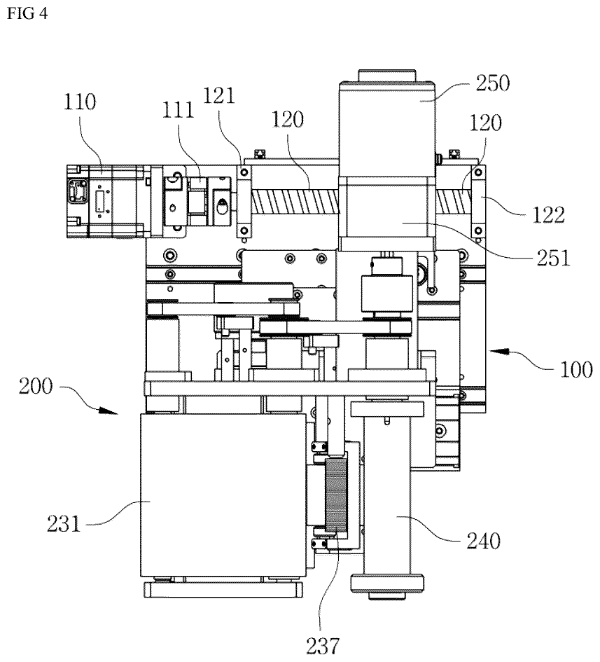

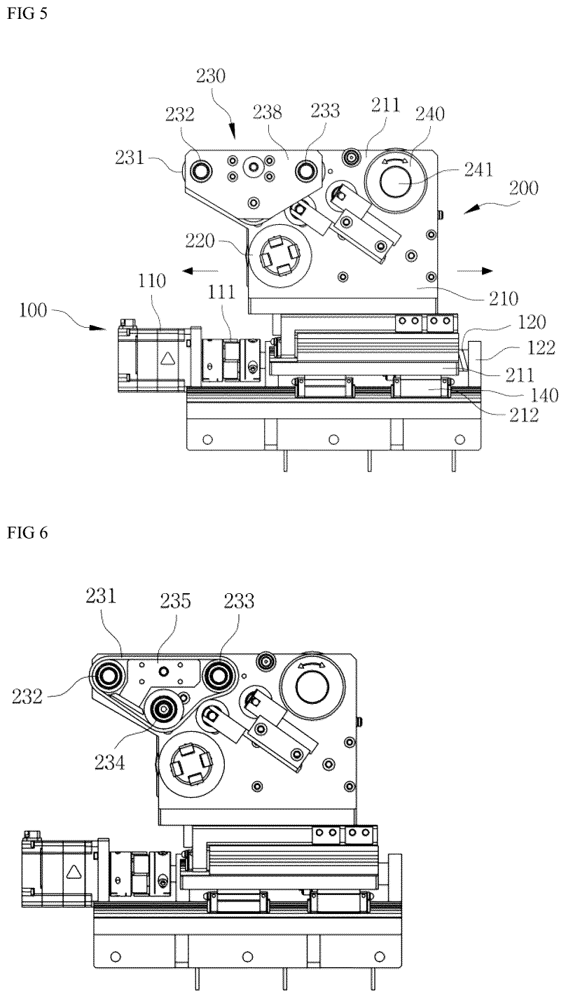

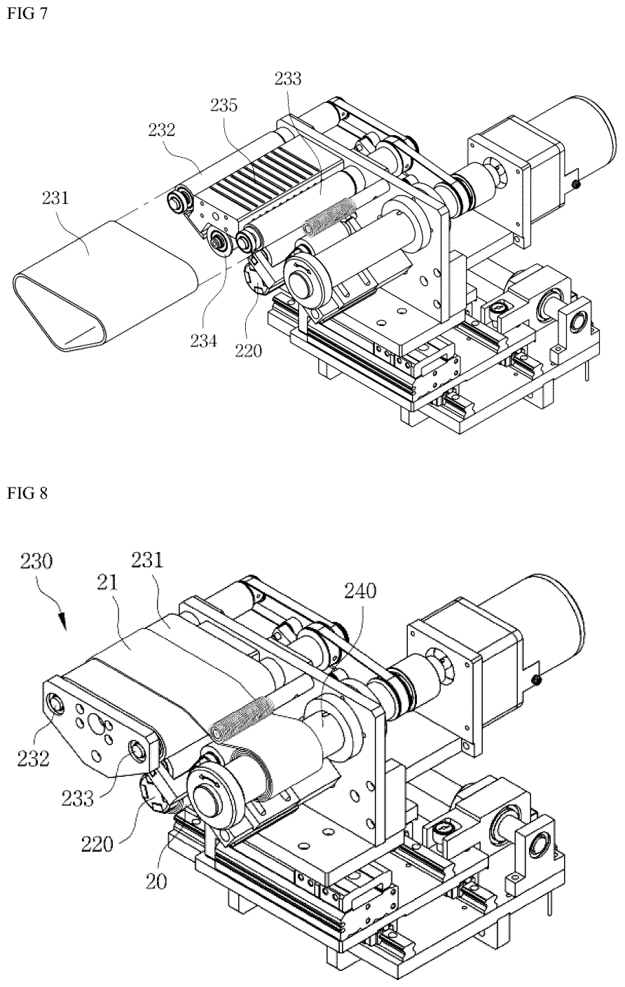

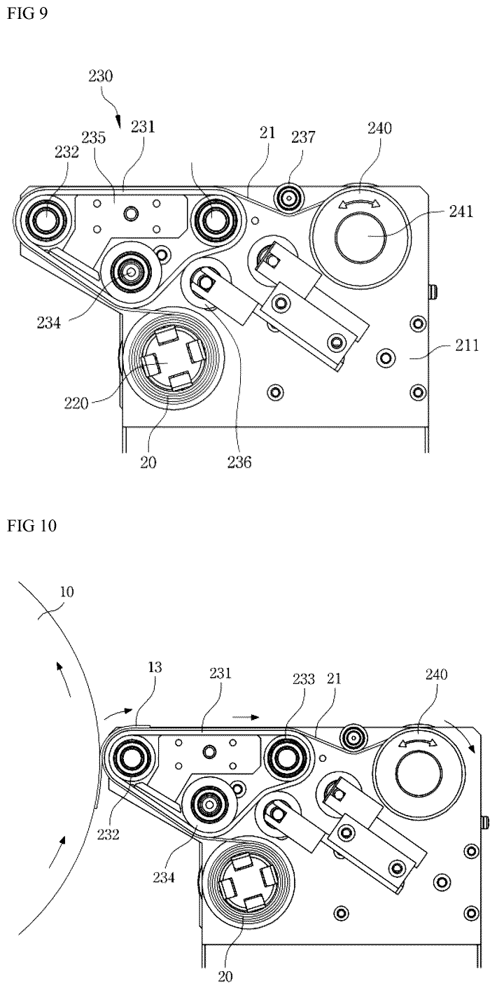

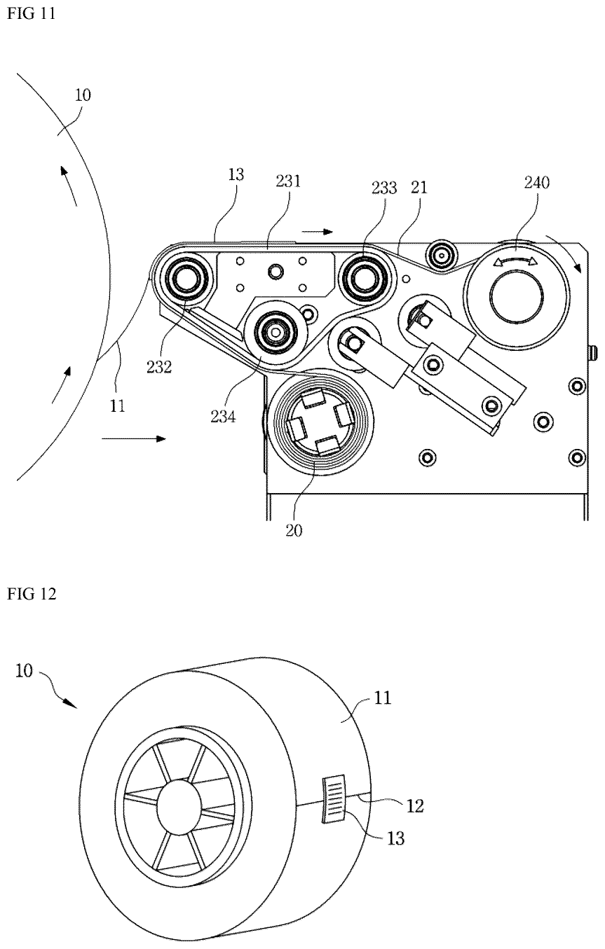

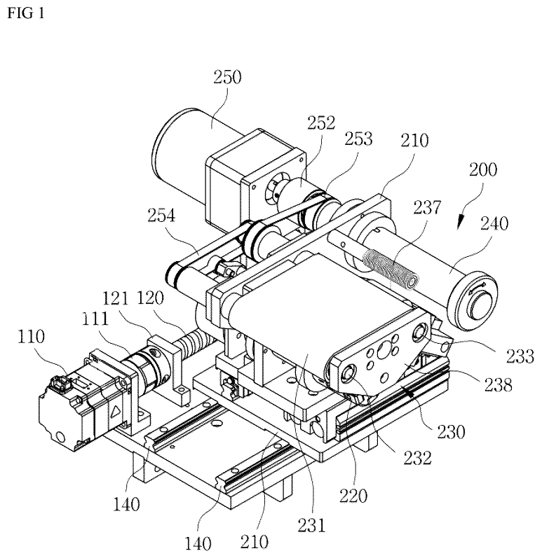

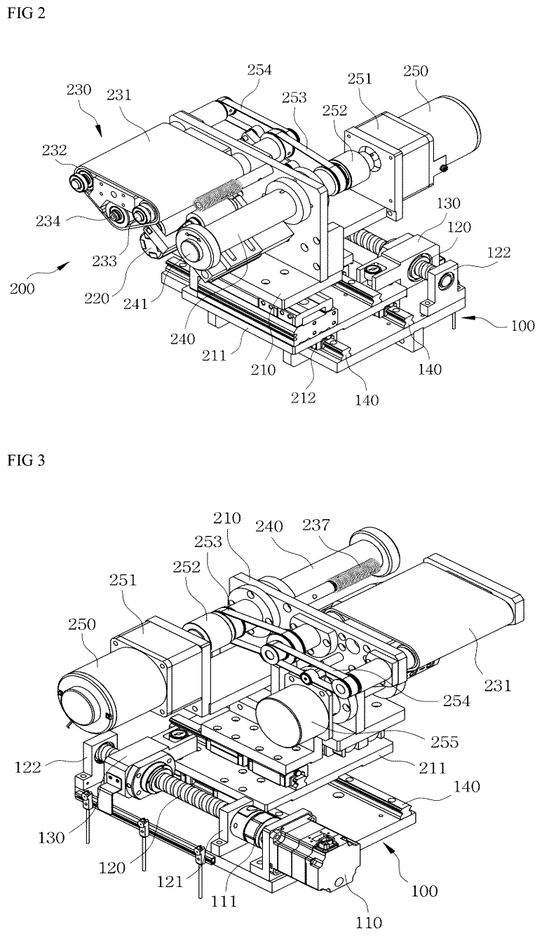

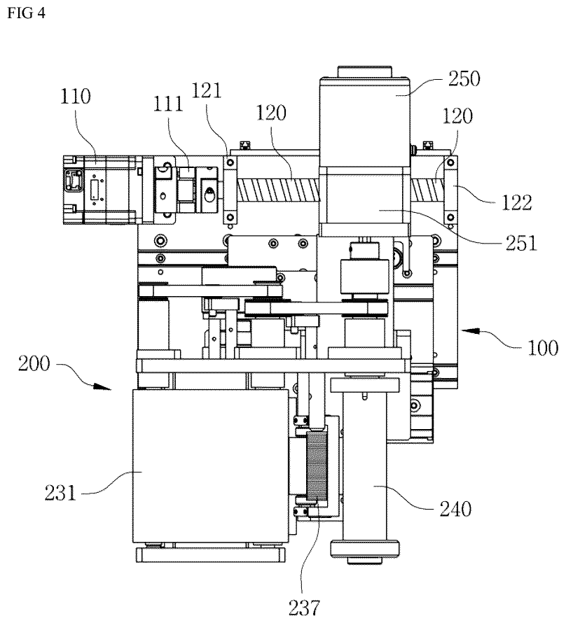

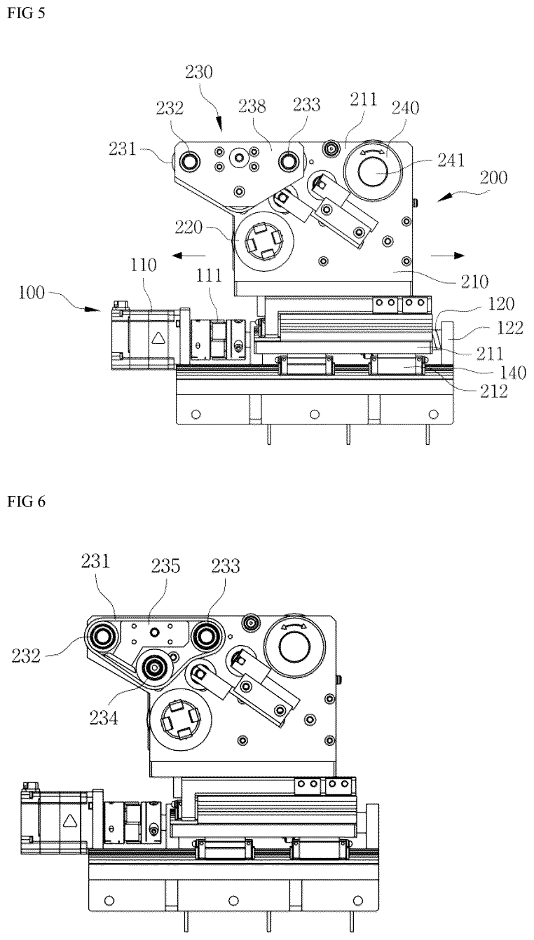

FIG. 1 is a perspective view of a device for automatically removing a finish tape attached to a film member winding roll according to an embodiment of the present invention, FIG. 2 is a perspective view of FIG. 1 at another angle, FIG. 3 is a rear perspective view of FIG. 1, FIG. 4 is a plan view of FIG. 1, FIG. 5 is a front view of FIG. 1, FIG. 6 is a view illustrating a state in which a cover is removed in FIG. 5, and FIG. 7 is a perspective view of a state in which a transfer part is separated in FIG. 2.

Referring to FIGS. 1 to 7, the device for automatically removing a finish tape attached to a film member winding roll according to the embodiment of the present invention includes a finish tape removing part 200.

The finish tape removing part 200 includes a mounting frame portion 210, a tape mounting portion 220, a separation removal portion 230, and a tape collecting portion 240.

As an embodiment, the mounting frame portion 210 may be formed in an L-shape. The mounting frame portion 210 is mounted so that the tape mounting portion 220, the separation removal portion 230, and the tape recovering portion 240 may rotate upward.

The tape mounting portion 220 is rotatably installed on one side of the mounting frame portion 210, and a separation removal tape roll 20 is mounted thereon. The tape mounting portion 220 is equipped with the separation removal tape roll 20, and when a wound separation removal tape 21 is withdrawn, an adhesive surface of separation removal tape 21 faces the outside, and the separation removal tape 21 is transferred by a surface frictional force between the separation removal tape 21 and a transfer portion 231 of the separation removal portion 230.

The tape mounting portion 220 is connected to a third driving portion 255 for rotating and driving the tape mounting portion 220 at a rear surface of the mounting frame portion 210 and performs a rotation operation by driving the third driving portion 255. Meanwhile, an example in which the driving portion is a driving motor is described in the present embodiment, but the present invention is not limited thereto, and various modifications are possible.

The separation removal portion 230 is provided to be spaced apart from the tape mounting portion 220 and guides the driving while rotating so that the separation removal tape 21 of the separation removal tape roll 20 mounted on the tape mounting portion 220 is withdrawn, and collected and wound on the tape collecting portion 240. The separation removal portion 230 allows the adhesive surface of the separation removal tape 21 to face the outside and allows the adhesive surface to be attached to the adjacent finish tape 13 of the film member winding roll 10 to separate the finish tape 13 from the film member 11. The separation removal portion 230 is installed adjacent to the tape mounting portion 220.

The separation removal portion 230 includes a transfer portion 231 having a certain cushion and at least one support formed inside the transfer portion 231 to support the transfer portion 231 and provide a rotational force. An example in which the transfer portion 231 is a continuous belt is described in the present embodiment, but the present invention is not limited thereto, and various modifications in which one roller may be used may be possible. The support may include a first support portion 232 and a second support portion 233 formed on both inner ends of the transfer portion 231 and a third support portion 234 located below the first support portion 232 and the second support portion 233. An example in which the support is a roller is described in the present embodiment, but the present invention is not limited thereto, and various modifications are possible.

The first support portion 232 and the second support portion 233 are connected to a rotary shaft of a second driving portion 250 through a first power transmission unit 253 and a second power transmission unit 254 and are configured to rotate in conjunction with rotational driving of the second driving portion 250. An example in which the power transmission unit is a power transmission belt is described in the present embodiment, but the present invention is not limited thereto, and various modifications are possible.

At least one of the transfer portion 231 and at least one support may have a cushion. That is, various modifications are possible, for example, only the transfer portion 231 may have a cushion, only the at least one support may have a cushion, or both the transfer portion 231 and the at least one support may have a cushion.

As an embodiment, the transfer portion 231 may be made of silicone or rubber having a certain cushion, and the separation removal tape 21 transferred while in contact with a surface applies a frictional force, and thus the separation removal tape 21 is easily transferred to the tape collecting portion 240. Further, the transfer portion 231 is provided close to a portion of the first support portion 232 protruding to one side and comes into contact with a portion of the finish tape 13 of the rotating film member winding roll 10 with a certain pressure.

In this way, the certain pressure and contact configuration toward the outside of the transfer portion 231 through a portion of the first support portion 232 provides a result that the adhesive surface of the separation removal tape 21 transferred while in contact with a surface of the transfer portion 231 is attached to the finish tape 13 of the film member winding roll 10.

The tape collecting portion 240 is installed close to the separation removal portion 230 and collects the separation removal tape 21 to which the finish tape 13 introduced through the separation removal portion 230 is attached.

The tape collecting portion 240 is rotatably installed on the mounting frame portion 210, is connected to the rotary shaft of the second driving portion 250 on the rear surface of the mounting frame portion 210, and is rotationally driven at a constant rotational speed and a constant torque through a reducer 251 and a torque limiter 252.

By driving the second driving portion 250, the first support portion 232 and the second support portion 233 of the separation removal portion 230 and the tape collecting portion 240 rotate in conjunction with each other.

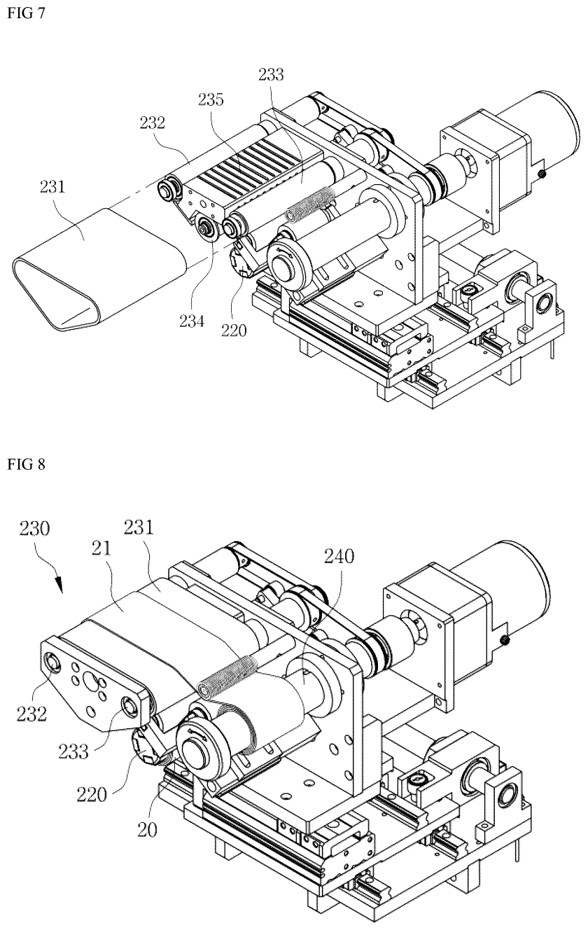

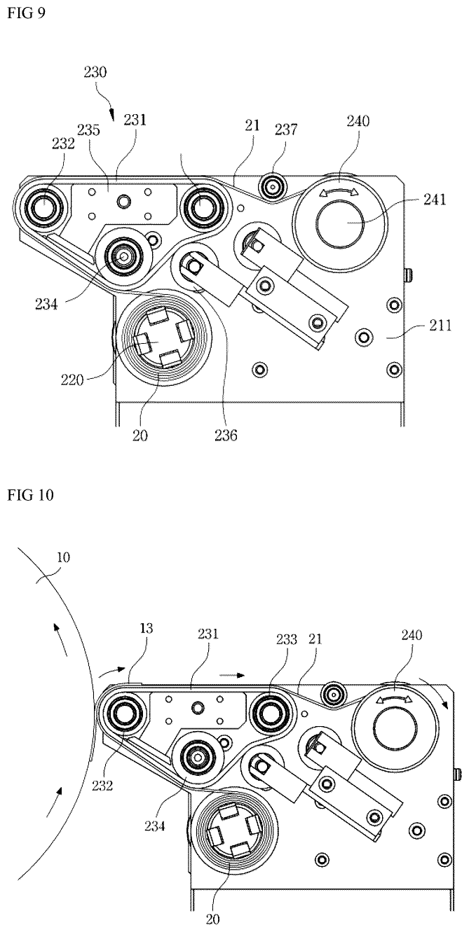

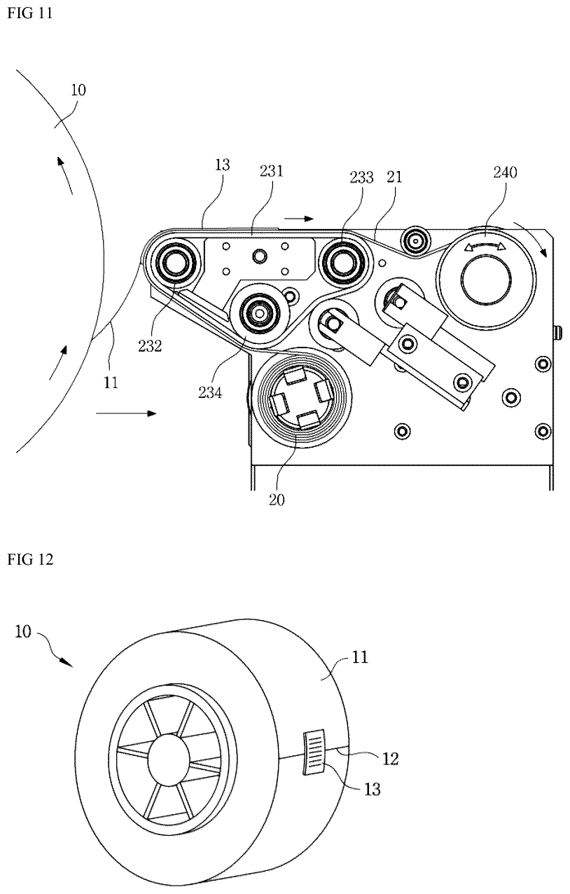

FIG. 8 is a diagram in which a separation removal tape is mounted according to the embodiment of the present invention, and FIGS. 9 to 11 are enlarged configuration diagrams of a separation removal portion for describing an operation state of the present invention.

As illustrated in FIGS. 8 to 10, a transfer portion tension support portion 236 and a tape tension support portion 237 are rotatably mounted on the mounting frame portion 210.

The finish tape removing part 200 may further include a coupling frame portion 211 under the mounting frame portion 210. The coupling frame portion 211 may be mounted on a rail 140 of a base part 100 formed thereunder and move to a predetermined distance. The coupling frame portion 211 includes a rail seating portion 212 formed on a bottom surface thereof and seated on the rail 140 of the base part 100, and one side thereof is connected to a direction changing portion 130 of the base part 100.

According to the embodiment of the present invention, the device for automatically removing the finish tape attached to the film member winding roll may further include the base part 100. The base part 100 is configured to move the finish tape removing part 200 to a predetermined distance. The base part 100 includes a first driving portion 110 formed on one side thereof, a rotation screw 120 that rotates in place by driving the first driving portion 110, the direction changing portion 130 which is mounted on the rotation screw 120, of which the other side is fixed to the coupling frame portion 211 of the finish tape removing part 200, and which converts a rotational movement of the rotation screw 120 into a linear movement, and moves the coupling frame portion 211 according to the linear movement, and a pair of rails 140 on which the rail seating portion 212 of the finish tape removing part 200 is seated. Undescribed reference numeral 111 is a reducer, and undescribed reference numerals 121 and 122 are a support of the rotation screw 120.

When the first driving portion 110 rotates forward, the rotation screw 120 is driven to rotate forward, and thus the base part 100 formed in this way moves the direction changing portion 130 to the left side as illustrated in FIG. 5 so that the separation removal portion 230 of the finish tape removing part 200 approaches the film member winding roll 10 that is not illustrated. In contrast, when the first driving portion 110 is driven to rotate reversely, the rotation screw 120 rotates reversely, and thus the base part 100 moves the direction changing portion 130 to the right side as illustrated in FIG. 5 and returns the finish tape removing part 200 to an original position thereof.

An operation and an effect of the device for automatically removing the finish tape attached to the film member winding roll according to the embodiment of the present invention as described above will be described with reference to FIGS. 8 to 11.

First, the separation removal tape roll 20 is mounted on the tape mounting portion 220 of the finish tape removing part 200, a tip of the separation removal tape 21 is withdrawn and held on the transfer portion 231 such that the adhesive surface faces the outside, and then the tip is fixedly wound on the tape collecting portion 240.

When the separation removal tape roll 20 is completely mounted as illustrated in FIGS. 8 and 9, the base part 100 is driven to move the finish tape removing part 200 to a side surface on which the film member winding roll 10 is located. That is, when the first driving portion 110 is driven to rotate forward, the rotation screw 120 rotates forward, and thus the direction changing portion 130 moves the finish tape removing part 200 to a location in which the film member winding roll 10 is located as illustrated in FIG. 10.

When the separation removal portion 230 of the finish tape removing part 200 comes into contact with the film member winding roll 10, the first driving portion 110 is stopped to stop the movement of the finish tape removing part 200 and the second driving portion 250 and the third driving portion 255 are driven. Thus, the tape mounting portion 220 and the tape collecting portion 240 are rotationally driven, and the transfer portion 231 of the separation removal portion 230 also rotates in conjunction with the rotational driving.

According to the rotation of the transfer portion 213, the separation removal tape 21 is withdrawn from the tape mounting portion 220 and collected and wound onto the tape collecting portion 240.

At the same time, the film member winding roll 10 starts to rotate in an opposite direction to the transfer portion 231, and as the adhesive surface of the separation removal tape 21 is attached to the finish tape 13 of the film member winding roll 10, the finish tape 13 is separated from the film member 11 and is directed to the tape collecting portion 240 through the transfer portion 231 while being attached to the separation removal tape 21. In this case, while the finish tape removing part 200 is spaced apart from the film member winding roll 10 as illustrated in FIG. 11, the film member 11 attached to the finish tape 13 is cut by a cutting device that is not illustrated. Thus, the finish tape 13 is wound on the tape collecting portion 240 while attached to the separation removal tape 21, and the film member winding roll 10 is in a state in which the finish tape 13 is removed, stops the rotation, and is moved for other processes.

In the embodiment of the present invention, in the film member winding roll 10 in which a film member such as a secondary battery separator is wound on a bobbin, as the finish tape 13 attached to an end 12 of the film member 11 is automatically separated and removed, process automation efficiency can be increased, cut accidents that occur when the barcode tape is removed according to the related art can be prevented, and labor costs can be reduced.

According to the present invention, in a film member winding roll in which a film member such as an electrode roll or a separator is wound on a bobbin, a finish tape attached to an end of the film member is automatically separated and removed, and thus process automation efficiency can be improved, accidents such as cuts, which occur when the finish tape is removed using a conventional method, can be prevented, and labor costs can be reduced.

Further, the present invention enables fully unmanned automatic material exchange for a secondary battery winder and a capacitor winder.

Although the present invention has been described with reference to embodiments illustrated in the drawings, the description is merely illustrative, and those skilled in the art to which the technology belongs could understand that various modifications and other equivalent embodiments may be made. Thus, the true technical scope of the present invention should be determined by the appended claims.

What is claimed is:

1. A device for automatically removing a finish tape attached to a film member winding roll, the device comprising a finish tape removing part configured to remove the finish tape attached to the film member winding roll,
wherein the finish tape removing part includes:
a mounting frame portion;
a tape mounting portion rotatably installed on one side of the mounting frame portion;
a separation removal portion that is spaced apart from the tape mounting portion, allows an adhesive surface of a separation removal tape to face an outside, and separates the finish tape from the film member while the adhesive surface is attached to the finish tape of an adjacent film member winding roll; and
a tape collecting portion that is spaced apart from the separation removal portion and collects the separation removal tape to which the finish tape introduced through the separation removal portion is attached.

2. The device of claim 1, wherein the tape mounting portion includes a third driving portion configured to rotationally drive the tape mounting portion at a rear surface of the mounting frame portion.

3. The device of claim 1, wherein the separation removal portion includes:
a transfer portion; and
at least one support provided inside the transfer portion and configured to support the transfer portion and provide a rotational force.

4. The device of claim 3, wherein the support includes a first support portion and a second support portion formed at both inner ends of the transfer portion and a third support portion located below the first support portion and the second support portion.

5. The device of claim 4, wherein the first support portion and the second support portion are connected to a rotary shaft of a second driving portion through a first power transmission unit and a second power transmission unit and rotate in conjunction with rotational driving of the second driving portion.

6. The device of claim 5, wherein the tape collecting portion is rotatably installed in the mounting frame portion and is connected to the rotary shaft of the second driving portion on a rear surface of the mounting frame portion.

7. The device of claim 3, wherein at least one of the transfer portion and the at least one support has a cushion.

8. The device of claim 1, wherein the finish tape removing part further includes a coupling frame portion that is mounted on a rail of a base part formed on a lower surface of the mounting frame portion and moves to a predetermined distance.

9. The device of claim 8, wherein the coupling frame portion includes a rail seating portion formed on a lower surface thereof and seated on the rail of the base part and is connected to a direction changing portion of the base part on one side thereof.

10. The device of claim 1, further comprising a base part configured to move the finish tape removing part to a predetermined distance.

11. The device of claim 10, wherein the base part includes:
a first driving portion formed on one side thereof;
a rotation screw that rotates in place by driving the first driving portion;
a direction changing portion which is mounted on the rotation screw, of which the other side is fixed to the coupling frame portion of the finish tape removing part, and which converts a rotational movement of the rotation screw into a linear movement, and moves the coupling frame portion according to the linear movement; and
a pair of rails on which a rail seating portion of the finish tape removing part is seated.

12. The device of claim 1, wherein the separation removal portion guides driving while rotating so that a tape of a separation removal tape roll mounted on the tape mounting portion is withdrawn and is collected and wound on the tape collecting portion.
